(19) United States
(12) Patent Application Publication
(10) Pub. No.: US 2010/0114366 A1
(43) Pub. Date: May 6, 2010

(54) DISPENSERS PROVIDING CONTROLLED DISPENSING AND CONTROLLED DISPENSING METHODS

(75) Inventors: ABBY C. CASE, Green Bay, WI (US); Daniel J. Geddes, Appleton, WI (US); Bret A. Kuehneman, Neenah, WI (US); Michael Ray Kilgore, Little Suamico, WI (US); Christopher M. Reinel, Neenah, WI (US); Antonio M. Cittadino, Appleton, WI (US)

Correspondence Address: Georgia-Pacific LLC, 133 Peachtree Street NE - GA030-41, ATLANTA, GA, 30303, US

(73) Assignee: GEORGIA PACIFIC CONSUMER PRODUCTS, LP, ATLANTA, GA (US)

(21) Appl. No.: 12/574,617

(22) Filed: Oct. 6, 2009

Related U.S. Application Data
(60) Provisional application No. 61/104,660, filed on Oct. 10, 2008.

(51) Int. Cl. G06F 17/00; B65D 83/08; G08B 21/00

(52) U.S. Cl. 700/232; 221/43; 221/1; 340/686.6

(57) ABSTRACT

Dispensers and method for controlled dispensing of products, preferably paper products, are discussed in this patent disclosure. Various embodiments of the present invention can comprise a housing, a separating assembly, a feed mechanism, and an advancing mechanism. The housing can support inner components of the dispenser. The housing can hold a stack of paper product to be dispensed. The separating assembly can comprise a separating member. The separating member can separate one or more napkins from the stack. The separating member can be controlled by a controller for controlled dispensing operations. The feed mechanism can move the separated napkin or napkins toward a dispensing slot for dispensing. The advancing mechanism can advance the stack of napkins such that, as the stack is depleted from one end of the stack, a remainder of the stack is advanced toward the separating member for dispensing. Other aspects, embodiments, and features are also claimed and described.

### CROSS REFERENCE TO RELATED APPLICATION & PRIORITY CLAIM

This application claims priority to and the benefit of U.S. Provisional Patent Application No. 61/104,660, filed 10 Oct. 2008, which is incorporated herein by reference in its entirety as if fully set forth below.

### TECHNICAL FIELD

Embodiments of the present invention generally relate to dispensers, and more specifically, to dispensers providing controlled dispensing of product and controlled dispensing methods to provide product according to controllable methods.

### BACKGROUND

Dispensers, such as napkin dispensers, are generally configured to enable end users to retrieve product, such as napkins, for use. Conventional dispensers, while serving their respective purposes, enable end users to freely obtain many napkins at once with no control mechanism and also tend to allow napkins to be soiled due to contact with surrounding environments. Excessive distribution of napkins and soiled napkins can lead to waste and, therefore, unnecessary operating expenses.

Various conventional dispensers are known. For examples, known dispensers are discussed in U.S. Pat. No. 7,234,610 to Skarda, U.S. Pat. No. 6,892,898 to Boone, U.S. Pat. No. 6,872,653 to Boone, U.S. Pat. No. 6,622,888 to Boone, U.S. Pat. No. 6,519,505 to Formon, U.S. Pat. No. 4,065,028 to Merila, and U.S. Pat. No. 3,726,435 to Williams. The dispensers discussed in these patents, however, do not enable adequate control of product dispensing to avoid excessive waste, reduce costs, and enable dispensing of clean napkins.

What is needed, therefore, are improved dispensers to provide controlled dispensing of product and improved dispensing methods to provide product according to controllable methods. It is to such dispensers and dispensing methods that the various embodiments of the present invention are directed.

### BRIEF SUMMARY OF EXEMPLARY EMBODIMENTS

Various embodiments of the present invention are directed toward dispensers that reduce excessive distribution of the product to be dispensed and provide unsoiled napkins. Dispensers according to embodiments of the present invention can dispense interfolded or non-interfolded napkins. Embodiments of the present invention are not be limited to dispensing napkins (as discussed in more detail below). For example, dispensers according to the present invention can be implemented to dispense other products, such as paper towels, tissues, rolled material, web material, or many other items desired for dispensing. Several exemplary embodiments are summarized below.

Briefly described some embodiments include dispensers configured to dispense product in a controlled fashion. For example, a dispenser can comprise a pair of spaced apart spindles. The spindles can be disposed proximate a housing. The spindles can be configured to contact product at varying locations. As an example, a first spindle of the pair can be configured to separate one or more sheets of product from the product. The first spindle can be configured to rotate in tandem with a second spindle of the pair to dispense one or more sheets of product from the housing. In some embodiments, the second spindle may be a stationary axial member. In combination with the first spindle, the second spindle can retain unseparated product within the housing to enable controlled dispensing of product.

In other embodiments, the present invention provides dispensers for sequentially dispensing sheet product. For example, a dispenser can generally comprise one or more of a housing, a separating spindle, a separating assembly, and a retaining spindle. The housing can be configured to receive a stack of sheet product. The separating spindle can have one or more surface projections. The separating spindle can be configured to frictionally engage the stack. The separating assembly can be configured to rotate the separating spindle. The separating spindle and a retaining spindle can be mounted at one end of the housing. The spindles can be spaced apart from each other. The spindles can also generally define a dispensing plane from which one or more napkins are dispensed along a dispensing direction.

Embodiments of the present invention also include controlled dispensing methods. According to some method embodiments, the present invention can include methods of dispensing sheet product from a dispenser. Such methods can generally include arranging a plurality of axial members for use with a housing that holds product to be dispensed and configuring a first axial member of the plurality of axial members to engage and rotatably separate one or more sheets of product. Method embodiments can also include arranging the first axial member and a second axial member to allow a predetermined number of separated sheets to be dispensed from the housing and retain un-separated sheets in the housing.

Still yet, other embodiments of the present invention can include dispensers that generally include a housing module, a product feed module, and a controller. The housing module can be configured to receive a stack of napkins having panels arranged generally perpendicular to the magazine axis. The product feed module can be configured to be detachably affixed to the housing module. The product feed module can comprise a separating spindle and a retaining spindle. The separating spindle can have one or more surface projections for frictionally engaging the stack of napkins. The separating spindle and a retaining spindle can be mounted at one end of the housing. The spindles can be generally parallel to each other and arranged generally in a dispensing plane. Napkins can be dispensed along the dispensing plane. Dispensers can also include a controller configured to dispense napkins from an aperture defined by the product feed module according to a predetermined dispensing algorithm.

Still yet, other dispenser embodiments can generally comprise an outer body, a separating assembly, a feed mechanism, and an advancing mechanism. The outer body can comprise a housing for supporting one or more inner components of a dispenser. For example, a housing can hold a stack of napkins or other product for dispensing. A separating assembly can comprise a separating member, such as separating spindle. A separating spindle can be configured to separate one or more napkins from a napkin supply (e.g., a napkin stack). A feed mechanism can be configured to move a separated napkin or napkins toward a dispensing slot for dispensing. An advancing mechanism can advance a napkin supply (e.g., a napkin stack), as depleted, during dispensing operations. Napkin stack advancement can be toward a dispensing aperture (e.g. a slot), from which napkins can be provided to users. In addition, napkin stacks can be advanced toward a separating spindle so individual napkins can be provided to a user in one or more controlled or metered methods in accordance with embodiments of the present invention as discussed herein.

In some embodiments, the present invention provides napkin dispensers for sequentially dispensing individual napkins. Napkin dispensers can generally comprise a housing, a separating spindle, a separating assembly, a retaining assembly, and a follower. The housing can enclose a dispensing magazine. The dispensing magazine can have an axis arranged along a dispensing direction. The dispensing magazine can be configured to receive a stack of napkins with their panels arranged generally perpendicular to a magazine axis. The separating spindle can include one or more surface projections for frictionally engaging a stack of napkins. The separating assembly can be configured to rotate or provide rotational energy to the separating spindle.

The retaining spindle, separating spindle, and a follower can be arranged to aid in dispensing operations. For example, the retaining spindle and the separating spindle can be mounted at one end of a dispensing magazine. The retaining spindle and the separating spindle can also be arranged generally parallel to each other and in a dispensing plane. The follower can be arranged generally parallel to the dispensing plane. The follower can be slidably mounted and biased to advance the napkin stack along a dispensing direction. Upon depletion of the stack, the follower can advance the stack so that it contacts the separating spindle and retaining spindle. The separating spindle and the retaining spindle can be spaced apart to engage the napkin stack at opposing end portions of napkin panels. The separating spindle and the retaining spindle can retain the stack of napkins in the magazine while at rest. The separating spindle and the retaining spindle can dispense a single napkin upon rotation (e.g., inward or outward) of the separating spindle over a predetermined distance.

As used herein, product includes many types of product for dispensing including, but not limited to, sheet product, stacked napkins, stacked wipes, and folded towels. Thus, while embodiments may be discussed herein as stacked napkin dispensers, it should be understood that such embodiments are equally applicable to stacked wipes, folded towels, and many other products that users desired to be dispensed in a controlled or metered fashion. In addition, product may be discussed herein as being included in a bundle. Bundles can include product adjoined or stacked together, such as a bundle of stacked napkin, stacked wipes, or folded towels. In some embodiments, a product bundle may include product placed next to each other or product intertwined with adjoining product pieces. In addition, in certain embodiments, bundles may be held together in a bound fashion or bundled together without a fastener.

Other aspects and features of embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures, all embodiments of the present invention can include one or more of the advantageous features discussed herein. In other words, while one or more embodiments may be discussed as having certain advantageous features, one or more of such features may also be used in accordance with the various embodiments of the invention discussed herein. In addition, while discussion contained herein may, at times, focus on napkin dispensers, embodiments of the present invention can also be used for many other dispenser types. In similar fashion, while exemplary embodiments may be discussed below as being device, system, or method embodiments, it should be understood that such exemplary embodiments can also be configured as devices, systems, and methods even though not expressly discussed as such.

### BRIEF DESCRIPTION OF THE DRAWINGS

FIG. 1 illustrates a housing of a dispenser according to some embodiments of the present invention.

FIG. 2 illustrates a side perspective view of a dispenser comprising various internal components according to some embodiments of the present invention.

FIG. 3 illustrates a schematic diagram of a side cross-sectional view of a dispenser according to some embodiments of the present invention.

FIG. 4A illustrates a lateral cross-sectional view of a separating spindle according to some embodiments of the present invention.

FIG. 4B illustrates a lateral cross-sectional view of a separating spindle according to other embodiments of the present invention.

FIG. 4C illustrates a lateral cross-sectional view of a separating spindle according to yet other embodiments of the present invention.

FIGS. 5A-5M illustrate various views of modular housing dispenser embodiments in accordance with some embodiments of the present invention.

FIG. 6 illustrates a perspective view of a controlled dispenser according to some embodiments of the present invention.

FIGS. 7A-7N illustrate various embodiments of dispenser elements (also referred to as spindles or rollers) according to some embodiments of the present invention.

FIG. 8 illustrates a logical flow diagram of a controlled dispensing method in accordance with some embodiments of the present invention.

### DETAILED DESCRIPTION OF PREFERRED & ALTERNATIVE EMBODIMENTS

To facilitate an understanding of aspects, principles, and features of the various embodiments of the present invention, embodiments of the present invention are explained herein with reference to its implementation in illustrative embodiments. For example, aspects of the invention are described in the context of dispensers for paper napkins. The dispensers, however, are not limited for use as napkin dispensers. Rather, the dispensers can be implemented whenever dispensers would be beneficial for dispensing materials or products. For example, dispensers can be implemented for various sheet products—bundled, connected to each other, or interfolded.

As used herein, the terms “sheet product” or “sheet products” are inclusive of many items and materials. For example, sheet product includes natural and/or synthetic cloth or paper sheets. Sheet products may also include both woven and non-woven articles. There are a wide variety of nonwoven processes and they can be either wetlaid or drylaid. Some examples include hydroentagled (sometimes called spunlace), DRC (double re-creped), airlaid, spunbond, carded, paper towel, and meltblown sheet products. Further, sheet products may contain fibrous cellulosic materials that may be derived from natural sources, such as wood pulp fibers, as well as other fibrous material characterized by having hydroxyl groups attached to the polymer backbone. Examples of other sheet products include, but are not limited to, wipers, napkins, tissues, rolls, towels or other fibrous, film, polymer, or filamentary products.

The materials and components described hereinafter as making up the various elements of the dispenser are intended to be illustrative and not restrictive. Many suitable materials and components that would perform the same or similar functions as the materials and components described herein are included within the scope of dispenser embodiments discussed herein.

Referring now to the figures, wherein like reference numerals represent like parts throughout the views, the present invention will be described in detail. Generally, dispensers according to embodiments of the present invention can comprise a housing, a separating assembly, a feed mechanism, and an advancing mechanism (although not all are required). In some embodiments, one or more of these features can be incorporated into modular components that can be configured to be securedly affixable/detachable to each other to yield a dispenser (as discussed below).

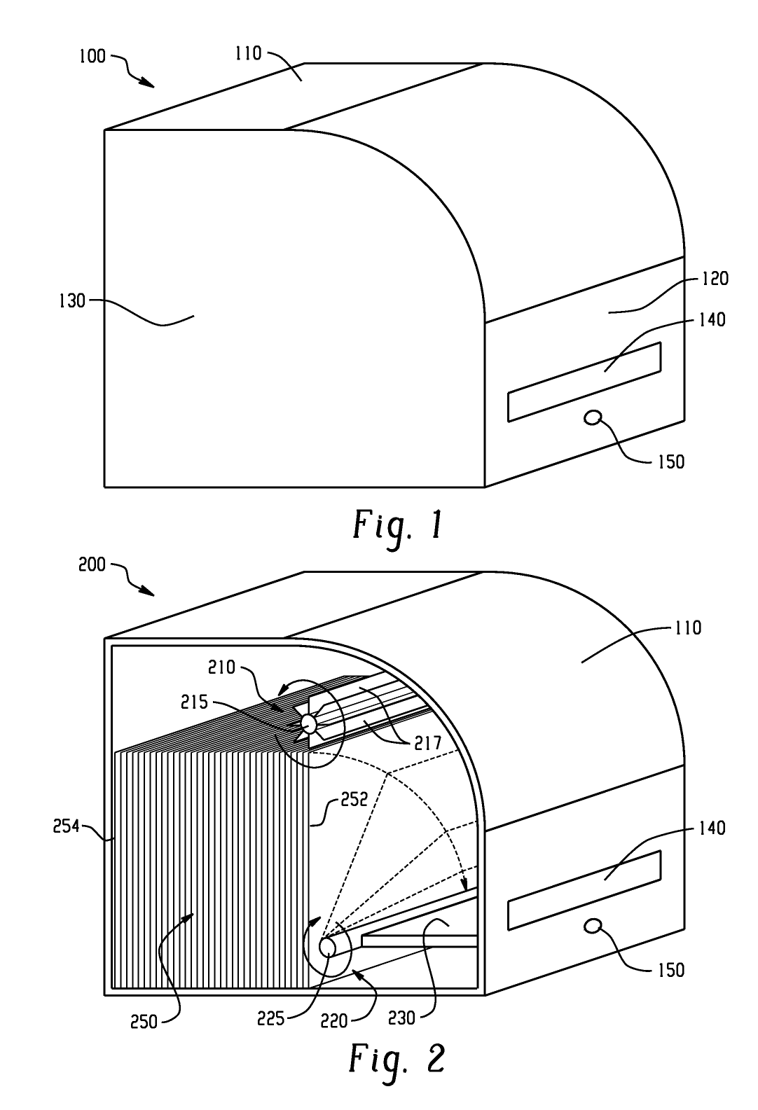

FIG. 1 illustrates a perspective view of a housing 110, or casing, of a dispenser 100 according to some embodiments of the present invention. The housing 110 can be composed of many materials sturdy enough to support inner components of the dispenser 100. For example, and not limitation, the housing 100 can comprise metal, such as aluminum or steel, a polymer, such as a plastic, or combinations thereof. The housing 100 can house various components of a dispenser as well as napkins (or other products) to be dispensed.

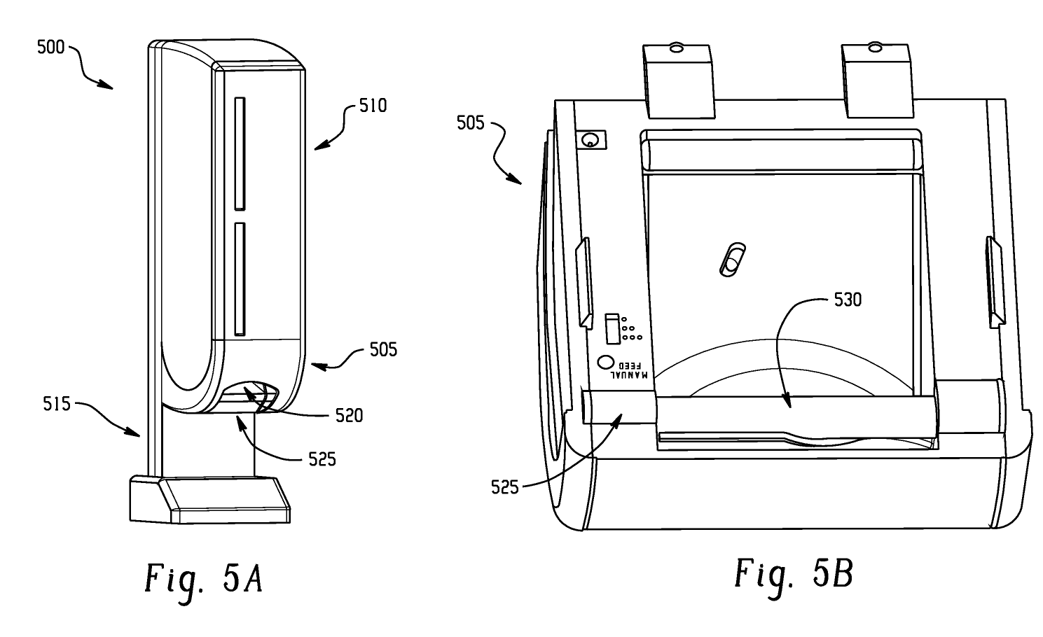

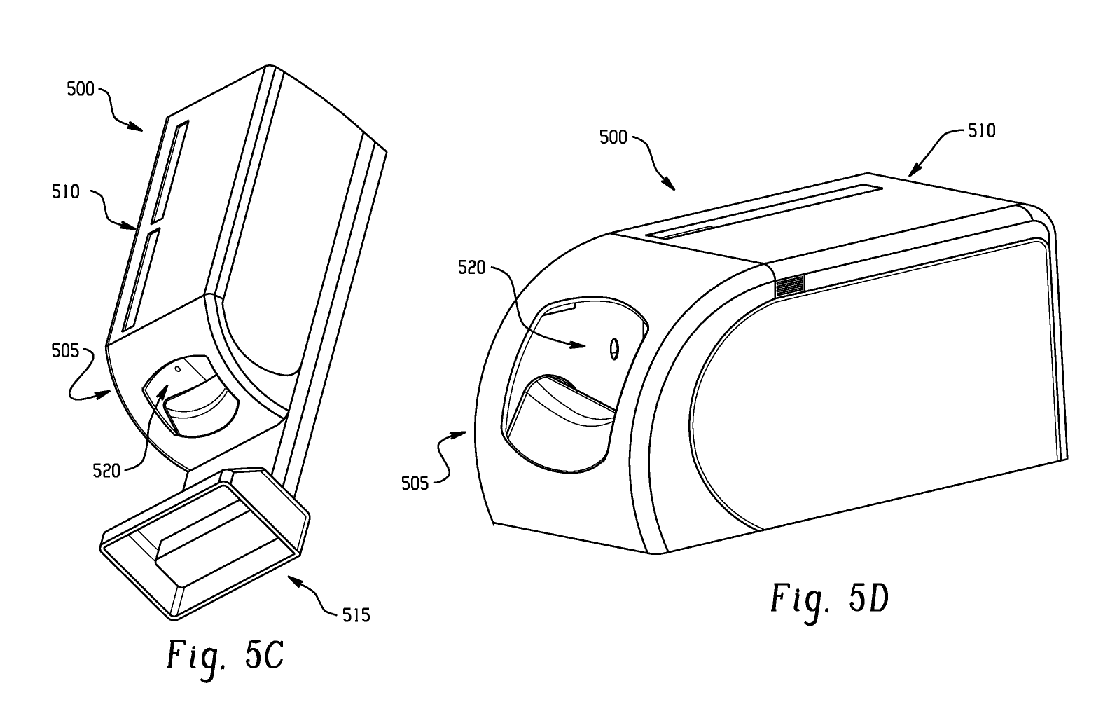

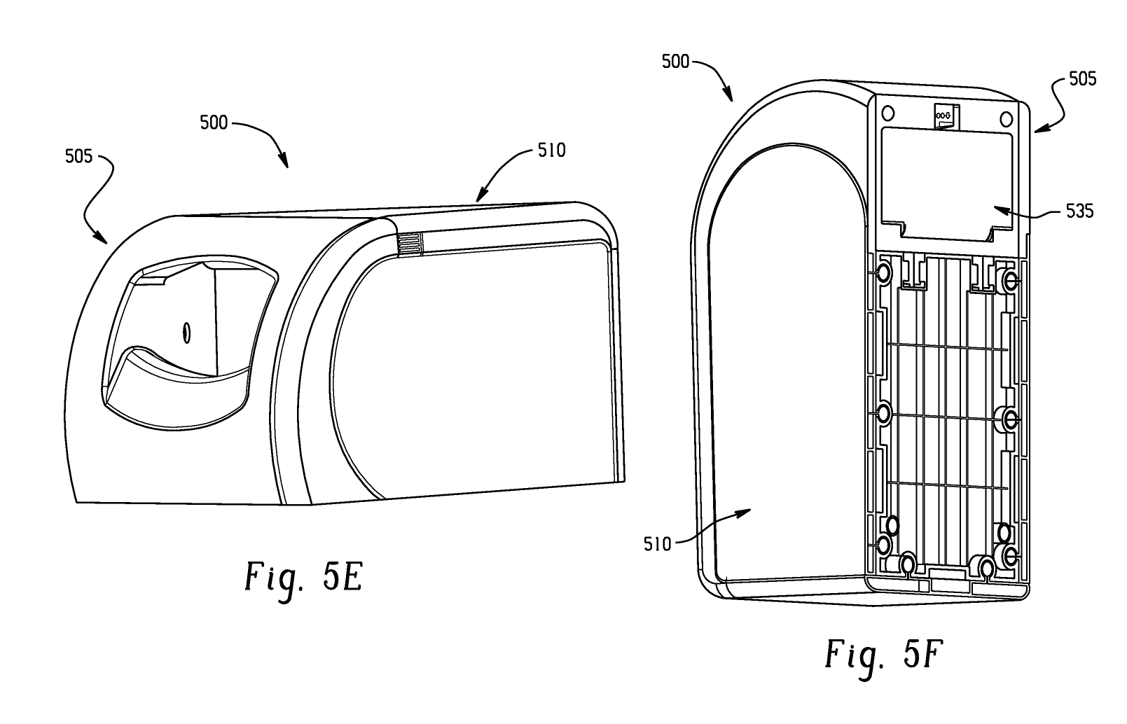

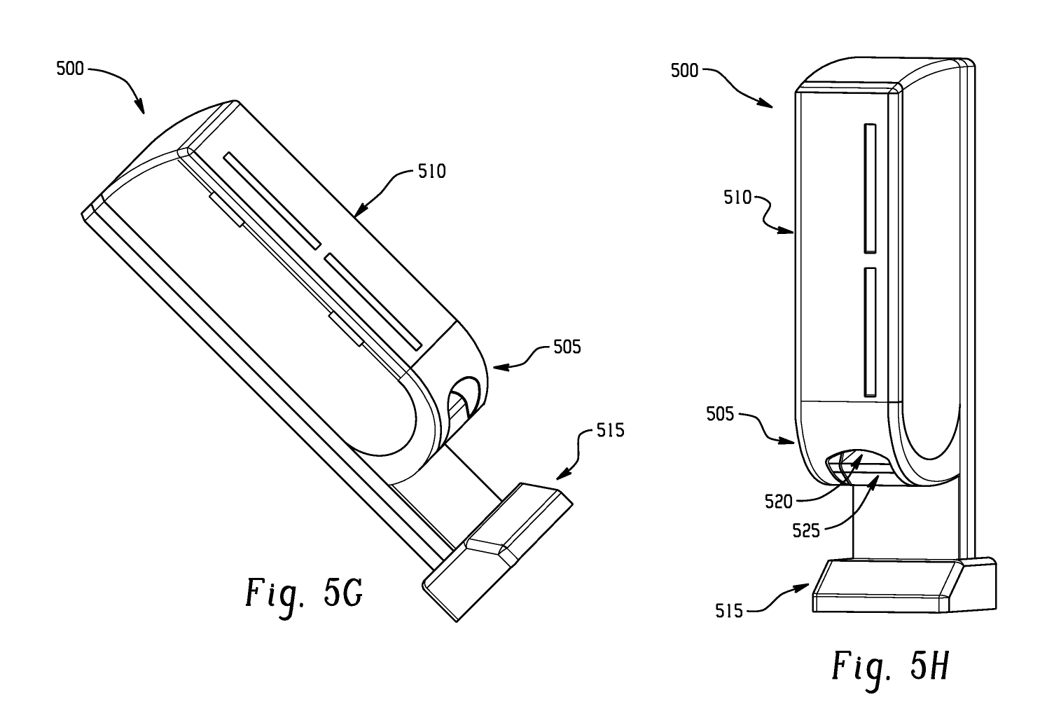

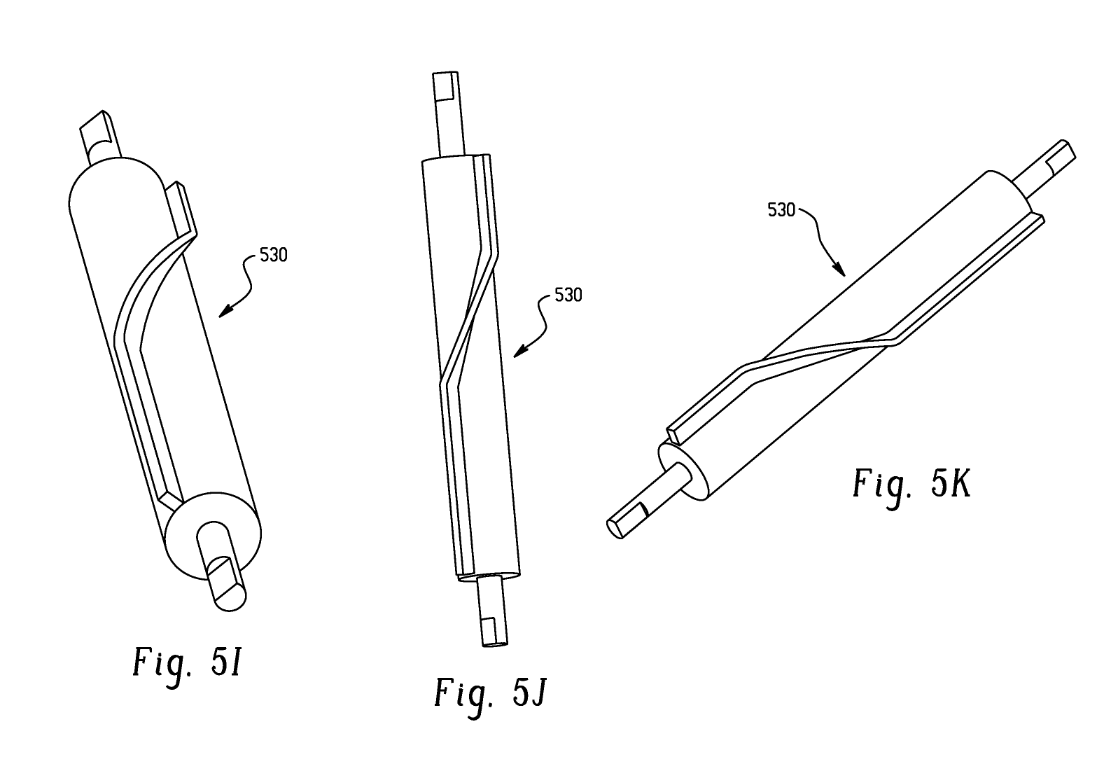

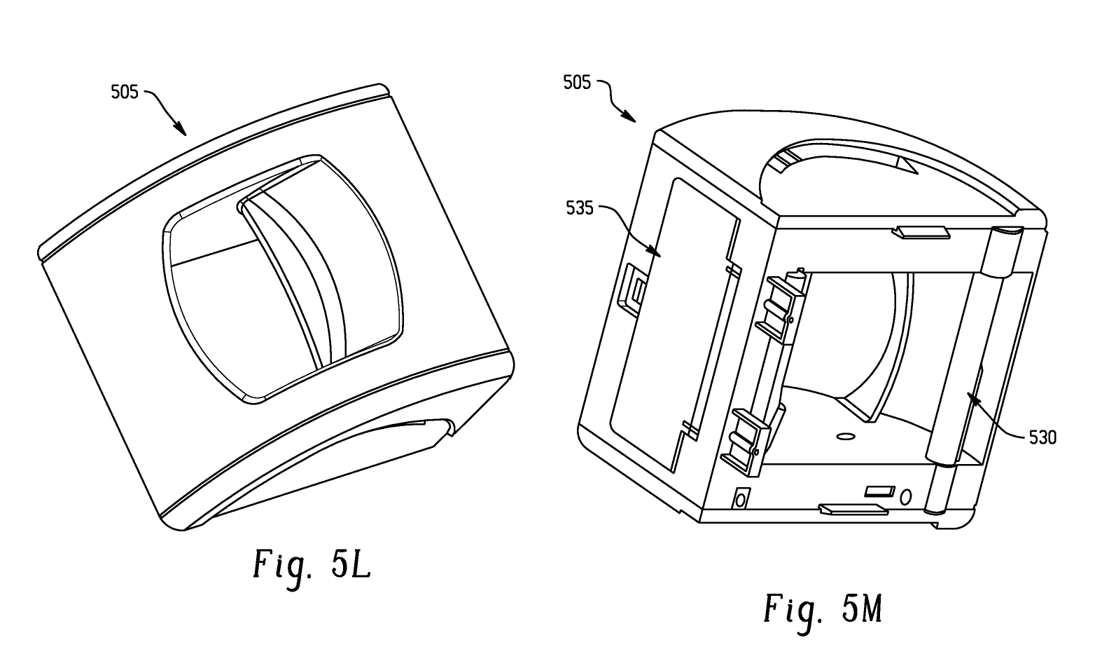

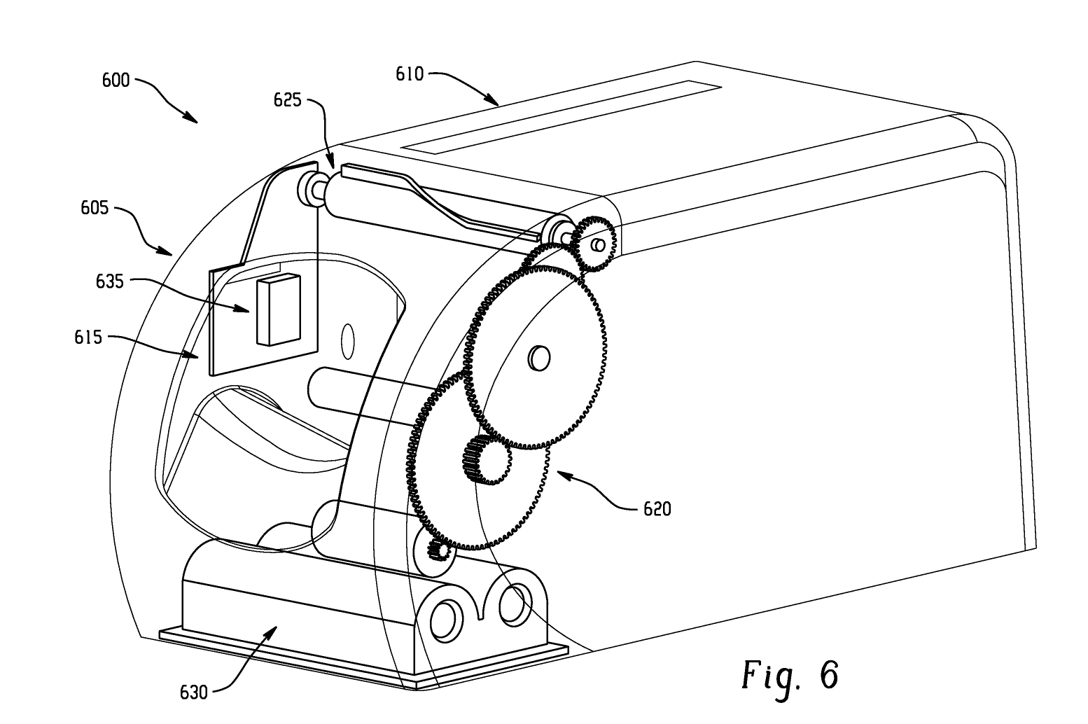

The housing 100 can be arranged and or shaped in various manners and may also include various modules (or sub-components). For example, the housing 100 can be configured to dispense product in vertical position, horizontal position, or combinations thereof. In addition, the housing 100 can be configured as a free-standing dispenser or configured to be mounted to another item (e.g., a wall mount configuration). Exemplary modular embodiments of the present invention are discussed below in more detail with reference to FIGS. 5-6.

The housing 110 generally comprises a first end 120 and a second end 130. At the first end 120, the housing 110 can define an aperture 140, such as an opening or dispensing slot. The dispensing slot 140 can be the means by which napkins exit the dispenser and/or are provided to a user. Indeed, a napkin or a portion of a napkin can be dispensed through the slot 140 so that a user can access a napkin.

The housing 110 can further comprise a sensor 150. The sensor 150 can detect when an object is in proximity to the sensor or to the housing. Exemplary sensors include, but are not limited to, infrared sensors and capacitive sensors. Detection can allow the dispenser 100 to dispense napkins automatically, as further discussed below. The sensor 150 can be a component of a sensing system provided for use with the housing 110 in some embodiments. A sensing system can include multiple sensor disposed at various locations relative to the housing 110. The sensor 150 can be disposed within the housing for use in some embodiments.

FIG. 2 illustrates a side perspective view of a dispenser 200 comprising various internal components according to some embodiments of the present invention. The dispenser 200 can comprise a separating assembly 210 and a feed mechanism 220. The separating assembly 210 can comprise a separating driver assembly (not shown) and a separating member 215, such as a separating spindle. The separating driver assembly can drive the separating spindle 215. The separating driver assembly can include a motor, a hand crank, or a combination thereof. The separating driver assembly can be located within the housing 110 and be configured to provide rotational energy to the separating spindle 215.

The separating spindle 215 can separate a controlled amount of material or product to be dispensed. For example the separating spindle 215 can separate a single napkin from a stack 250 of napkins. Alternatively, the separating spindle 215 can separate multiple napkins (e.g., two or three) at a time from the stack 250. In some embodiments, the separating spindle 215 can separate a small stack of napkins (e.g., about 5 to about 10 napkins) from the main stack 250.

Embodiments of the present invention can dispense material or product being arranged in various stack arrangements or configuration. As an example, the stack 250 can comprise a first end 252 and a second end 254. The stack 250 can be orientated in the housing 110 so that first end 252 corresponds to the housing first end 120, and the second end 254 corresponds to the housing second end 130. The stack 250 can comprise interfolded napkins, non-interfolded napkins, non-folded sheet products, or other product to be dispensed.

By placing the separating spindle 215 proximate a napkin supply (e.g., the stack 250), one or more napkins can be removed from the stack for provision to a user. Indeed, the separating spindle 215 can be configured to separate napkins at the first end 252 of the stack 250. In some embodiments, the first end 252 of the stack 250 can be in proximity to the dispensing slot 140 so that separated napkins can be guided to the slot for provision to a user.

To aid in providing napkins to users for various embodiments and dispensing applications, a variety of spindle designs can be utilized. As an example, the separating spindle 215 (sometimes referred to as a flipper), can have one or more projections 217, such as teeth, pins, paddles, or otherwise. For example and not limitation, the separating spindle 215 can comprise a series of paddle-like projections 217. As shown in FIG. 2, each projection 217 can extend along a length of the separating spindle 215 generally parallel to the separating spindle 215. Alternatively, the separating spindle 215 can comprise one or more helically configured projections extending longitudinally along a length of the separating spindle 215. A helically configured projection can wrap around the separating spindle's exterior surface approximately between approximately ½ time and approximately 2 times. The projections 217 can act as napkin engaging portions, which can engage and separate napkins. In some embodiments, the projection 217 can be a single, unitary projection disposed between ends of the spindle 215.

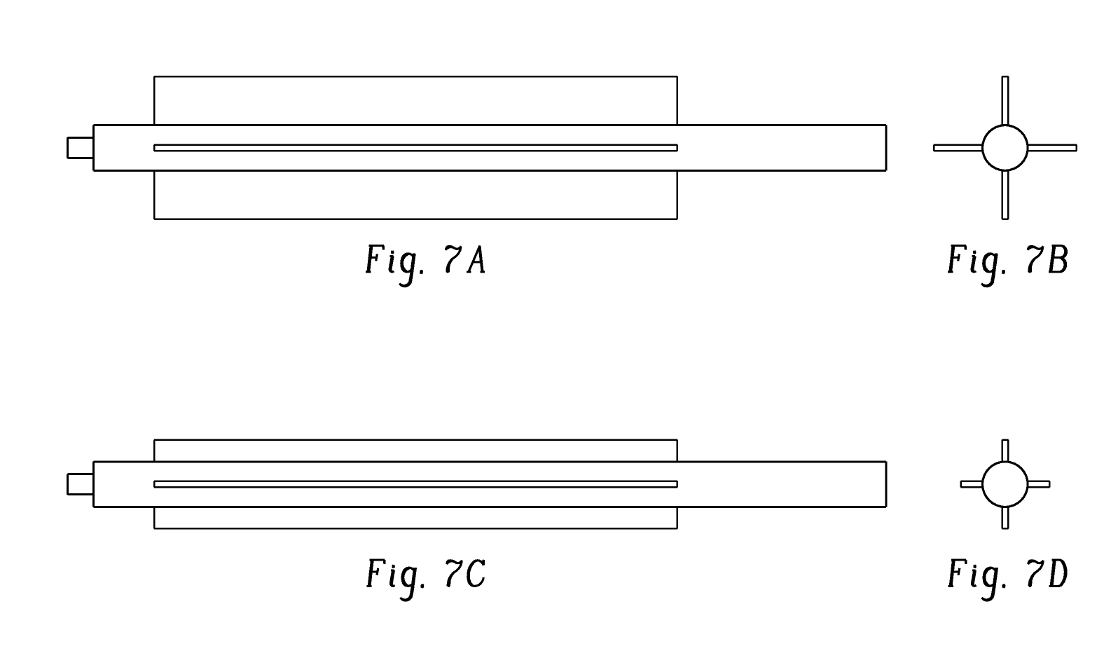

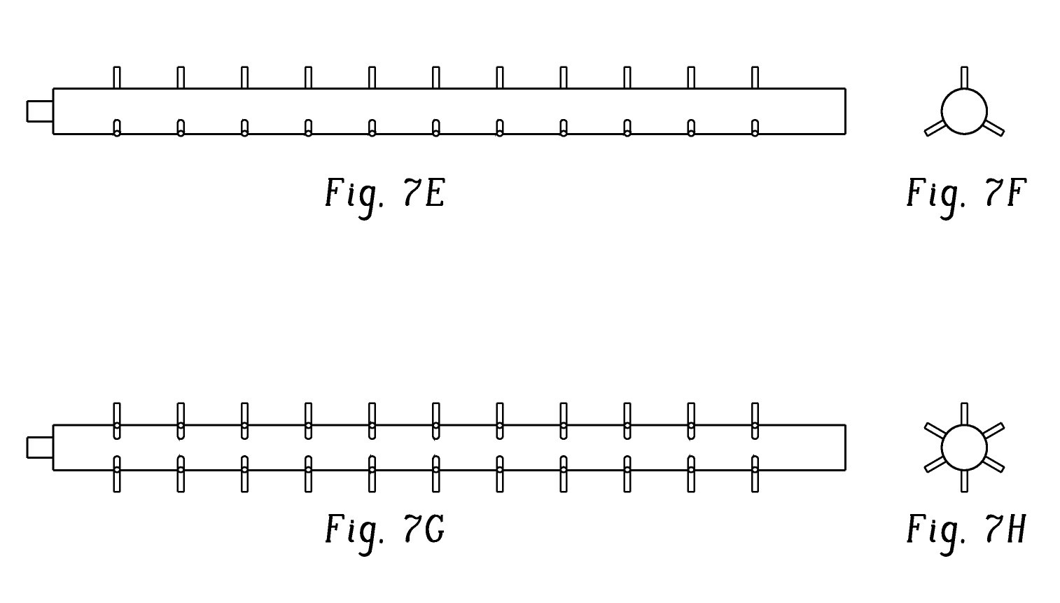

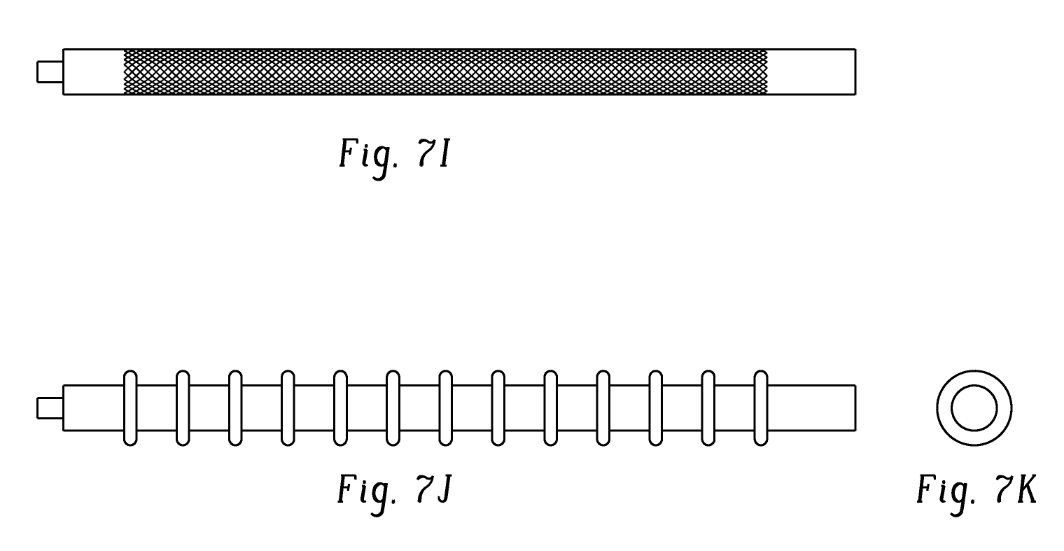

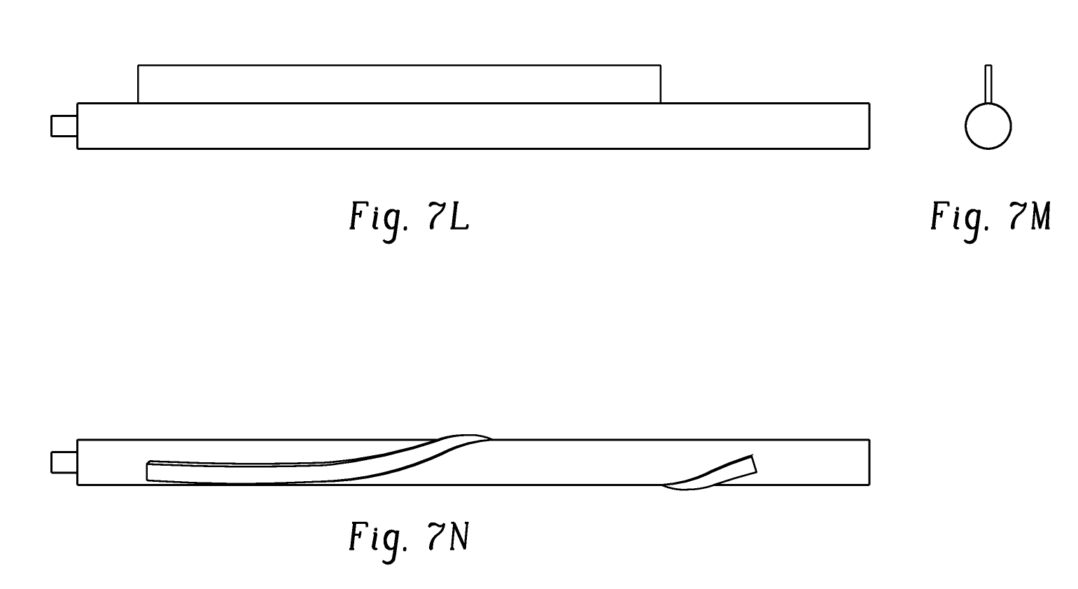

FIGS. 4A-4C illustrate lateral cross-sectional views of various separating spindle embodiments in accordance with some embodiments of the present invention. As shown, the paddles 217 of the separating spindle can have various shapes. Various shapes can be used to enable separation of a small number of napkins or items from the rest of the stack 250. FIGS. 7A-7N illustrate various embodiments of dispenser elements (also referred to as spindles) according to some embodiments of the present invention.

As shown in FIGS. 2, 4, and 7, spindles used in accordance with embodiments of the present invention can have varying features to aid in controlled dispensing. For example, separating spindles can be angled toward a follower at an offset angle of between about 2 degrees to about 15 degrees. Also, a helically configured napkin separator can engage a portion of a feed spindle at about 20% to about 80% of the length of the feed spindle. In addition, a helically configured napkin separator can engage a portion of the feed spindle that extends along the feed spindle over an axial distance of between about 35% to about 65% of the length of the feed spindle. And in some embodiments, a helically configured napkin separator can engage a portion of the feed spindle that is arranged about the longitudinal axis of the feed spindle such that it defines from about 0.5 to about 2 turns around the feed spindle over the length of the feed spindle. And in other embodiments, a helically configured napkin separator can engage a portion of the feed spindle that is arranged about the longitudinal axis of the feed spindle such that it defines from about 0.75 to about 1.5 turns around the feed spindle over the length of the feed spindle.

The configuration of the projections 217 can vary according to various dispenser embodiments. In some embodiments the shape or geometrical configuration of the projections 217 can correspond to, and may be partially dependent upon, physical characteristics of the product to be dispensed. For example, the arrangement of the projections 217 can be altered depending on the thickness, width, substrate, density, humidity, viscosity, and/or height of product to be dispensed. As a result some dispenser embodiments may be equipped to change arrangement and/or configuration due to the product for dispensing. In some embodiments, projections 217 can be configured to be detachably affixed to the spindle 215 to adjust dispensing characteristics. The one or more projections 217 can comprise elastomeric, flexible, rigid materials, or many other materials as desired.

The separating spindle 215 can rotate, thereby causing the projections 217 to be inserted between a first napkin and the remainder of the stack 250. In some embodiments, the separating spindle 215 and/or the projections 217 may be positioned to engage a surface of the first napkin facing toward opening 140 (FIG. 2). The first napkin, along with any napkins between the first napkin and the stack's first end 252, can then be separated from the stack 250. Altering configuration of the projections 217 from helical to paddle extensions can aid in enabling metered dispensing relative to rotation of the separating spindle 215. In addition, gearing the separating spindle's 215 coupling to a motor or hand crank can aid in controlled dispensing. For example, the spindle 215 can be geared to rotate a single revolution to separate a single sheet product in the stack 250. Other separation ratios can also be implemented and based on the gearing between the spindle 215 and the component imparting rotational energy on the spindle 215 (for example a drive motor or hand crank).

A separating driver assembly, or controller, can control the separating spindle 215 electronically or mechanically. For example and not limitation, the separating assembly 210 can comprise an external actuator (not shown), such as a crank. The crank can be coupled to the separating spindle 215. When the crank is turned, the separating spindle 215 can rotate accordingly, thereby separating one or more napkins from the stack 250. Alternatively, if the dispenser 100 comprises a sensor 150, as shown, the sensor 150 can detect when an object is in proximity to the sensor. Upon detection, the sensor 150 can provide a signal to a controller (e.g., a processor or a microcontroller (e.g., PIC16F887)) that in turn causes dispensing operations to occur. Also in some embodiments, the separating assembly 210 can comprise a motor for rotating the separating spindle 215. The sensor 150 can be in communication with the separating assembly 210. When a nearby object, such as a hand, is detected by the sensor 150, the motor of the separating assembly 210 can cause the separating spindle 215 to rotate, thereby separating one or more napkins from the stack 250.

As mentioned above, sensors may be used to aid in dispensing operations. In one embodiment, a sensor (not shown) can be a mechanical switch, such as a micro-switch, disposed so as to cause a change of state of the switch in response removal of a napkin from the dispensing slot 140. A micro-switch can be disposed proximate retaining roller 225 such that its actuation lever is actuated by the presence (and subsequent removal thereof) of a napkin. Other embodiments include an optical sensor configured to detect the presence or absence of napkin in the dispenser.

The feed mechanism 220 can comprise a retaining roller 225, or retaining spindle 225. The retaining roller 225 can contact the napkin stack 250. The retaining roller 225 can keep the stack 250 secure and in a desirable position and orientation. As the separating spindle 215 rotates, or after an instance of the separating spindle's rotation, the retaining roller 225 can rotate, thereby feeding a separated napkin or napkins upward and over the retaining roller 225. In some embodiments, the feed mechanism 200 can be configured to separate one or more napkins as desired relative to rotations or revolutions of the separating spindle 215. By gearing the spindle 215 with an appropriate separation ratio, the feed mechanism can aid in controlled dispensing of napkins. For example, it may be desire to separate two napkins per rotation of the spindle 215. The component or components (e.g., drive motor or hand crank) imparting rotational energy to the spindle 215 can be similarly geared to interact with the spindle 215 at an appropriate separation ratio. When separated, napkins can land on a dispensing tray 230 for provision to a user via aperture 140.

The dispensing tray 230 can be configured in many orientations according to the various embodiments of the present invention. For example and not limitation, the tray 230 can be generally parallel to the bottom of the housing. And in some embodiments, the tray 230 can slant downward from the dispensing slot 140 toward the retaining roller 225. This slanting configuration can help guide napkins from the roller 225 to the dispensing slot 140. The retaining roller 225 can force the napkin or napkins on to the tray 230 such that a portion of the napkin or napkins is pushed through the dispensing slot 140 and, therefore, accessible to a user of the dispenser 100. The retaining roller 225 can be driven by a mechanism similar to that driving the separating spindle 215. In some embodiments, the retaining roller 225 can be driven by the same mechanism similar that drives the separating spindle 215.

The retaining roller 225 can rotate in an opposite direction from the separating spindle 215. For example, as shown in FIG. 2, the separating spindle 215 can rotate counter-clockwise to separate napkins from the stack 250, while the retaining roller 225 can rotate clockwise to guide or force the separated napkins upward and toward the slot 140.

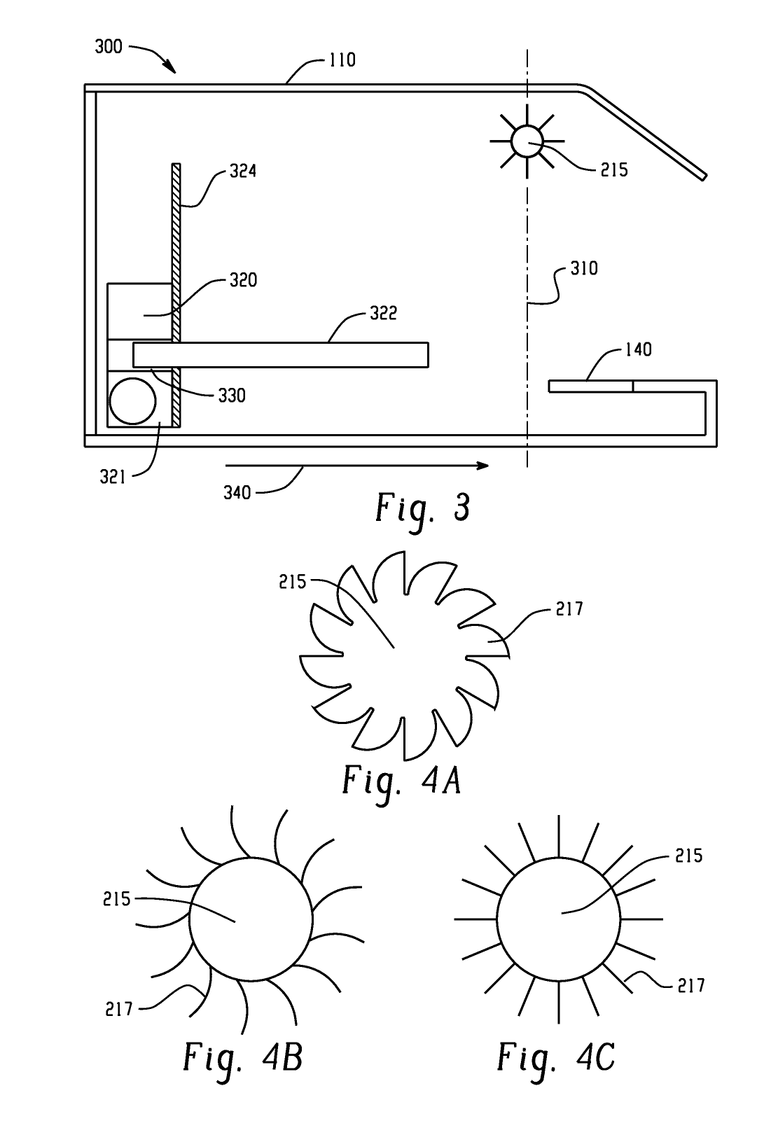

The separating spindle 215 and the retaining roller 225 can be oriented generally parallel or planar with respect to each other. The separating spindle 215 and the retaining roller 225 can define a dispensing plane 310 (see FIG. 3). This plane can define where napkins are separated and dispensing begins. The separating spindle 215 and the retaining roller 225 can be spaced apart such that they engage generally opposite portions of the stack 250, or one or more napkins at an end of the stack 250. For example and not limitation, as shown, the separating spindle 215 can engage an upper portion of napkins, while the retaining roller 225 engages a lower portion of napkins.

In some embodiments, the separating spindle 215 contacts the napkin stack 250 at between approximately ⅛ inch to approximately ½ inch from a top or bottom edge of the napkin stack 250. Additionally, the retaining roller 225 can contact the napkin stack 250 at approximately between ⅛ inch and ½ inch from an opposing edge of the napkin stack 250. In other embodiments of the present invention, positions of the separating spindle 215 and the retaining roller 225 can vary. For example, depending on the height and/or stiffness of the product to be dispensed, the positions of the roller can be altered to ensure dispensing properties as desired. As a result, the separating spindle 215 and the retaining roller 225 can be placed at varying positions relative to ends of a product bundle.

FIG. 3 illustrates a schematic diagram of a side cross-sectional view of an exemplary dispenser 300 in accordance with some embodiments of the present invention. In addition to the features of the above discussed embodiments, the dispenser 300 may also comprise an advancing mechanism 320, or follower, and a dispensing magazine 330. These features can also be used to aid in controlled dispensing of product. All of these features can be used in a dispenser configured for horizontal disposition and may not be desired for a dispenser configured for vertically dispensing product.

The advancing mechanism 320 can advance a stack 250 of napkins as the stack is depleted. For example, during dispensing or after one or more napkins are dispensed, the advancing mechanism 320 can advance the stack 250 forward toward the dispensing plane 310 so that more napkins can be dispensed. A base 321 of the advancing mechanism 320 can be slidably mounted in the housing 110 so that the base 321 advances with the napkin stack 250. Slidable mounting, however, is not required. Rather, slidable mounting can be a feature of some embodiments of the present invention.

The advancing mechanism 320 can also comprise a bottom support 322 and a retaining wall 324. The bottom support 322 and the retaining wall 324 can support the napkin stack 250. The bottom support 322 can act as a movable surface supporting an underside of the stack 250. The retaining wall 324 can be in contact with or in proximity to the second end 254 of the stack 250, supporting the stack 250 from the back as the stack 250 is advanced. As the bottom support 322 and the retaining wall 324 move toward the dispensing plane 310, the stack 250 can move toward the dispensing plane as well.

Additionally or alternatively, the advancing mechanism 320 can comprise a spring (not shown). The spring can be in communication with or generally disposed between both the napkin stack 250 and an inner portion of the second end 120 of the housing 110. The spring can be in a compressed state and configured for expansion. As the stack 250 is depleted, the spring can expand, thereby pushing the napkin stack 250 toward the dispensing plane.

The dispensing magazine 330 can comprise an assembly for holding the napkin stack 250. Because the advancing mechanism 320 can advance the stack 250 and the dispensing magazine 330 can hold the stack 250, the advancing mechanism 320 and the dispensing magazine 330 can share components. For example and not limitation, the bottom support 322 and the retaining wall 324, components of the advancing mechanism 320, can act as components of the dispensing magazine 330. Alternatively or additionally, the dispensing magazine 330 can comprise, for example, a track mounted on the bottom of the housing. The track can carry the napkin stack 250 while the advancing mechanism 320 advances the stack 250 along the track.

A longitudinal axis of the dispensing magazine 330 can define a dispensing direction 340. The dispensing direction 340 can be a direction in which the stack 250 moves toward the dispensing plane 310. The dispensing direction 340 can be generally perpendicular to the dispensing plane 310, but this is not required.

FIGS. 5A-5M illustrate various views of modular housing dispenser 500 embodiments and spindles in accordance with some embodiments of the present invention. It should be understood that modular components can possess and enable the above discussed features. For example, a feed module can include a separating spindle and a retaining spindle. And a housing module can include a magazine and follower assembly. For brevity, these details will not be further discussed below so it should be understood the various discussed module components can include the functionality of the features discussed above and shown in FIGS. 1-4.

As shown, the dispenser 500 can generally comprise a feed module 505, a housing module 510, and stand module 515. The housing module 510 can be configured to hold product for dispensing. The feed module 505 can be configured to dispense product from the housing module 510. The feed module 505 and the housing module 515 can comprise corresponding features enabling the feed module 505 and the housing module 515 to be detachably affixed to one another. Detachable affixment enables the feed module 505 and the housing module 515 to engage for locking together for use and disengage for servicing and/or filling. The stand module 515 can be configured for fixedly attachment to one or both of the feed module 505 and the housing module 515 to orient the two modules in a standing arrangement. In some embodiments, the stand module 515 may not be desired.

The dispenser 500 can also comprise other illustrated features. For example, the dispenser 500 can include a sensor module 520, a drive module 525, and a spindle module 530. The sensor module 520 can be used to detect presence of a user and to provide a user present signal to the drive module 525. In some embodiments, the sensor module 520 may not be desired. For example, if the drive module 525 is a mechanical drive mechanism (e.g., hand crank). In some embodiments, the drive module 525 can be electronically driven and at least partially controlled via the sensor module 520. The sensor module 520 can be located within the drive module 525 and/or the housing module 510. In some embodiments, the sensor module 520 can be configured as a capacitive sensor device.

The drive module 525 can be used to drive the spindle module 530. The spindle module 530 is preferably housed within one of the feed module 505 or the housing module 510. In some embodiments, the spindle module 530 can receive mechanical energy for provision to a napkin bundle. Such provision can yield a napkin from a bunch to a user.

The dispenser 500 can also include a power source module 535. The power source module 535 can be used to power one or more components of the dispenser 500. For example, the power source module 535 can be used to provide electronic power to the drive module 525 and/or the sensor module 520. The power source module 535 can be integrated with one or more of the housing module 515 or the feed module 505. In one currently preferred embodiment, the power source module can house mobile power sources, such as batteries, battery packs, or a combination thereof. In other embodiments, the power source module 535 can receive power from an AC source, a DC power network, or include solar cells. The power source module 535 can also include communication components enabling the module to communicate with a network to pass along dispenser status information and receive dispensing instructions.

FIG. 6 illustrates a perspective view of a controlled dispenser 600 according to some embodiments of the present invention. The controlled dispenser 600 can generally comprise a feed module 605 and a housing module 610. The controlled dispenser 600 can include one or more components discussed herein for desired dispensing operations. The housing module 610 can be configured to hold product for dispensing and the feed module 605 can be configured to dispense product from the housing module 610. The dispenser 600 can also comprise a sensor module 615, a drive module 620, a spindle module 625, and a power source module 630. The sensor module 615 can be configured to detect presence of a user and to provide a user present signal to the drive module 625 and/or an operating controller 635. The power source module 630, which in some embodiments may be solar cells, can be used to power various components of the dispenser 600 for automatic operation. The controlled dispenser 600 can include the controller 635 configured to control various dispensing operations of the dispenser 600.

FIGS. 7A-7N illustrate various embodiments of dispenser elements (also referred to as spindles or rollers) according to some embodiments of the present invention. Some of these elements can be used as a separating spindle or a feed spindle. Each of these varying dispenser elements will be discussed in turn below. FIGS. 7A-B illustrates a dispenser element having four unitary projections that are spaced apart at about 90 degrees from each other around the circumference of the dispenser element. FIGS. 7C-D illustrate a similar design but with projections having a lower degree of outward extension. FIGS. 7E-H show dispenser elements having a plurality singular projections extending from the core of the dispenser element. As shown in the cross-section drawings, FIGS. 7F and 7H, the projections can be spaced at equal locations around the core of the dispenser element. FIG. 7I shows a dispenser element with a friction surface disposed on the element core. The friction surface can be engraved or molded onto the surface of the element core. FIGS. 7J-K show an element core carrying several circular features that are spaced apart from each other. The circular features can be sized and shaped to snugly fit on the element core. FIG. 7M shows a dispenser element with a single, unitary projecting element disposed on the element core. And FIG. 7N shows a dispenser element having a single helical projection, and in some embodiments another helical projection can be added to provide a dispenser element with a double helical arrangement.

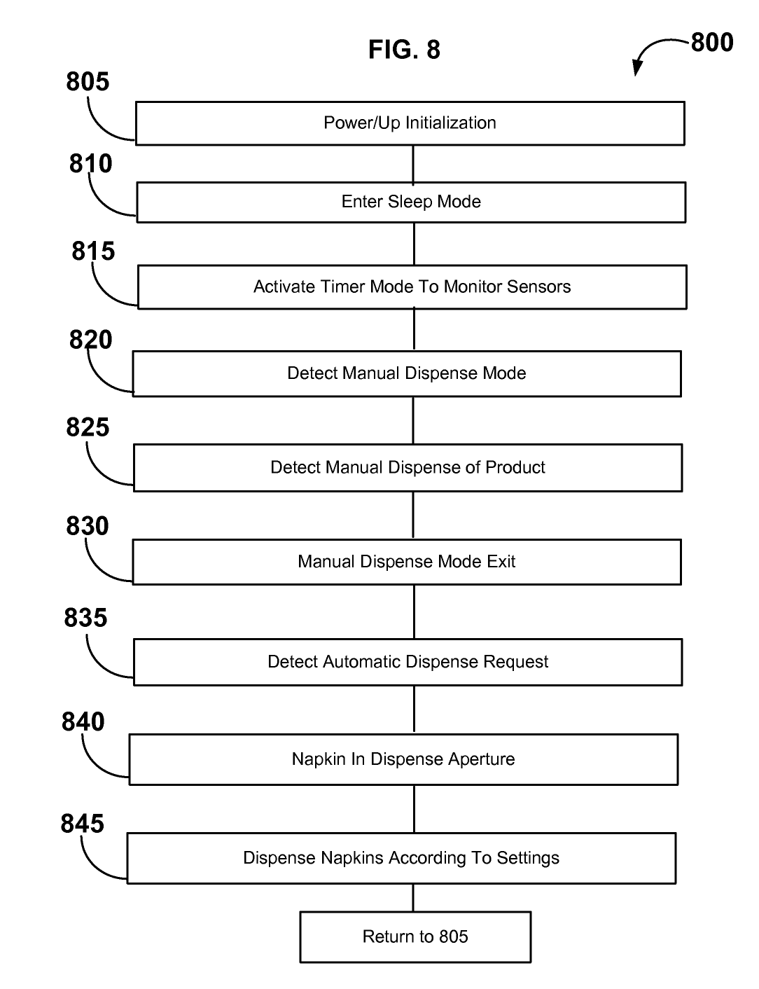

FIG. 8 illustrates a controlled dispensing method 800 in accordance with some embodiments of the present invention. Those skilled in the art will understand that method 800 can be performed in various orders (including differently than illustrated in FIG. 8), additional actions can be implemented as part of a method embodiment, and that some actions pictured in FIG. 8 or discussed below are not necessary. In addition, it should be understood that while certain actions illustrated in FIG. 8 may be discussed herein as including certain other actions, these certain other actions may be carried out in various orders and/or as parts of the other actions depicted in FIG. 8. Method embodiments of the present invention, such as the one depicted in FIG. 8, may be implemented with the devices and systems discussed herein. Method embodiments may also be coded in a programming language, stored in a memory, and carried out with a processor or microcontroller. Method embodiments can also include the use of component devices and a processor can be used to manage operation of component devices as desired.

The method 800 can initiate at 805 with a power initialization of a dispenser. At this stage, a dispenser can be turned on and perform an initialization check. Such a check can include determining if product housed in a dispenser is appropriate or capable of being used with a dispenser. An initialization check can also include checking if appropriate power levels are present for proper operation and checking existing product levels for dispensing operations. And finally an initialization check can include communications with a dispenser network.

After power up at 805, the method 800 can include entering a sleep mode at 810. Sleep mode 810 can include times when dispensing operations are not active. Sleep mode, however, can also include active monitoring to determine whether dispensing operations are being requested. For example, the method 800 can include the continued running of a timer (e.g., a 250 ms timer) and at the end of timing period a check can be made to see if recent stimulus has been provided. As illustrated, stimulus can come in the form of a request to perform automatic dispensing (at 815) or detection of manual dispenser operation occurring (at 820).

If manual dispenser operation is occurring, the method 800 can include dispensing product at 825. Manual dispensing operations can include monitoring whether a manual dispenser feature (e.g., a hand crank) is in use. And after product is dispensed, the manual dispense mode can be exited at 830. Continued monitoring of the manual dispensing feature can be used to determine when product has been dispensed in the manual dispense mode. At the end of a manual dispense mode, the method can include a return to the sleep mode 810.

Should automatic dispense mode be requested at sleep mode 810, the method can include entering an automatic dispensing mode. Automatic dispense mode determinations can be made when a sensor detects a user's hand near the dispenser. For example, the sensor can be an IR sensor. Upon a sensor detecting a user's hand, the method 800 can include determining whether product (e.g., a napkin) has been provided to a user via a an exit slot (or aperture). If so, the method 800 can return to sleep mode at 810. If not, the method 800 can dispense product according to predetermined settings at 845.

Method 800 can also include additional features for use in dispensing product from a dispenser. For example, a dispenser, during initialization at 805, can be configured to obtain information about product disposed within a dispenser. The product can be encoded with certain product identification information. And the dispenser can be configured to obtain product identification information by one or more sensing/detection methods. For example, in some embodiments a light source and a photodetector may be used to obtain product identification information. The light source and the photodetector can be placed within the dispenser in such a location as to obtain product identification information placed at one or more predetermined locations on the product. In such a configuration, the light source can direct light at a predetermined wavelength toward the product. The product can be configured to include a dye mark that will reflect back light provided by the light source. The photodetector can be configured to receive light reflected back by the dye mark.

The method 800 can also include configuring a dispenser to use at least a portion of the obtained product identification information to control dispensing operations. For example, a dispenser can be provided with a control system that can receive product identification information and in response use that received information to control product dispensing operations. A control system can include a micro-controller with one or more predefined dispensing control settings. For example, a controller upon receiving a signal from a photodetector can determine if the signal from the photodetector corresponds to one or more light wavelength signals. In some embodiments, if the received signal fails to satisfy a predetermined condition (e.g., greater than or less than a predetermined wavelength), the controller may place the dispenser in a lock out mode. For example, if product disposed within a dispenser, once illuminated, does not reflect back light at a certain wavelength, the dispenser can determine that the product is not appropriate, configured, or proper for use with the dispenser. In other embodiments, the controller may determine to vary dispensing rates of the dispenser based on obtaining product identification information from product to be dispensed.

The method 800 can also include continuous testing of product during dispensing operations. Such testing can be performed at predetermined intervals by a processor. In addition, such testing may be performed in response to end user activity receiving product from the dispenser. This enables a process to continuously monitor product for dispensing and end user interaction with a dispenser. Testing (and dispensing control in general) can be implemented as an IF-THEN-ELSE type of computer program or a state diagram algorithm.

In implementing the method 800, the inventors have devised various technical specifications for dispensing product. For example, in some embodiments, product to be dispensed can include an ink pattern printed on the product. The ink pattern can be selected to reflect light at predetermined wavelength when illuminated by a light source. An LED can be used as a light source and a photodiode detector can be used to receive light reflected back by an ink pattern disposed within the product. Upon receiving reflected light information from the photodiode detector, a controller can use this information to select a predefined dispensing program. For example, if napkin product A has a printed ink pattern wavelength of X nano meters and napkin product B has a printed ink pattern wavelength of X nano meters, a dispensing program (e.g., one stored within a memory or a controller's memory) can comprise dispensing multiple napkins if X nano meters are detected and dispensing only a single napkin if Y nano meters are detected. This feature advantageously enables a customer to select which product for use based on how the dispenser will operate when used with such product. In addition, a dispensing program can determine if product has or does not have an ink pattern and use this information to control dispensing operations (e.g., place dispenser in lock out mode when no ink pattern is detected).

Product used in accordance with method 800 (and other embodiments of the present invention) can have various advantageous features. For example, the product may be encoded with information in the form of an ultraviolet ink pattern. Such an ink pattern can not be seen by end users yet is not harmful to humans. The ink pattern can be formed in many ways. For example, the ink pattern may be a predetermined series of geometric shapes (e.g., series of dots, lines, rectangles); predetermined pattern series (e.g., weave pattern and cross hatching pattern); and have various different ink marks having differing reflected wavelengths. In other embodiments, product can be encoded in other fashions. Such other fashions can include count marks, weight/mass patterns, conductive fibers, embossing patterns, printed logos, magnetic inks/patterns, bar coding, RFID chips and other nano-sized microchips.

Method 800 (and the other embodiments of the present invention discussed above) can utilize a control system for dispensing product. A control system can generally include a controller and a sensing mechanism. The controller can be a low-power microcontroller capable of being powered by low voltage DC. The controller can be, for example, a PIC 16F887/TQFP. The sensing mechanism can include many types of detectors for receiving information encoded on a product. For example, the detector may be implemented with a bar-code reader, a photo diode detector, RFID receiver, capacitive sensor, inductive sensor, and the like. The sensing mechanism may also include a light source for illuminating product. For example, the light source may be implemented with ultraviolet LEDs and blue LEDs. Preferably, the light source is a low power consumption component.

The control system also preferably includes a power source (such as the power module discussed above) and dispensing mechanisms for dispenser operations (such as the feed and housing modules discussed above). The power source may include a battery pack, compartment for batteries, or input from a standard AC power source. In some embodiments, the power source may include integral solar panels for use in powering dispenser operations. While the power source can be provided to power dispenser control systems, such power source can also be used to power a dispensing mechanism. Indeed, some embodiments of the present invention can be automated, motorized dispensers configured to automatically dispense product to end users. It should be understood, however, that other embodiments the present invention require end users to initiate dispensing operations (e.g., crank or lever operation) to receive product from a dispenser.

The embodiments of the present invention are not limited to the particular formulations, process steps, and materials disclosed herein as such formulations, process steps, and materials may vary somewhat. Moreover, the terminology employed herein is used for the purpose of describing exemplary embodiments only and the terminology is not intended to be limiting since the scope of the various embodiments of the present invention will be limited only by the appended claims and equivalents thereof.

For example, some embodiments of the present invention can include electronic napkin dispensers and methods of dispensing napkins from dispensers. A product dispenser for dispensing product (such as napkins), includes a housing and a controller. The housing can have an exterior surface and define an interior space to hold product for dispensing. The controller can be operatively configured to at least one obtain information about product disposed at least partially within the interior space or located proximate the exterior surface at least partially proximate the exterior surface. The controller can also be operatively configured to control and/or modify dispensing operations of the dispenser in response to sensed/detected information associated with the product. In other embodiments, dispensers of the present invention can dispense paper towels, rolled product, folded product, unfolded product, liquids, and/or gels.

Still yet, embodiments of the present invention can include lock out control dispensing systems and methods. According to some embodiments, a product dispenser is provided with a device to detect product disposed within the dispenser and in response dispense the product. In some embodiments, the product disposed within the dispenser to be dispensed may be stacked product such as napkins, tissue paper, folded material, unfolded material, and many other items capable of being dispensed from a dispenser. The device used for detection may include a mechanical or electric control mechanism. The device can also include a control circuit or controller responsive to a detection device to control dispensing of a product. In some embodiments, control may include dispensing various products at different rates and also include not dispensing a predetermined set of products (i.e., lock out and suspend dispensing operations). In this manner, a dispenser can be preset to dispense products designed for use with the dispenser and also used to dispense products at different rates for various end-use applications.

Therefore, while embodiments of the invention are described with reference to exemplary embodiments, those skilled in the art will understand that variations and modifications can be effected within the scope of the invention as defined in the appended claims. Accordingly, the scope of the various embodiments of the present invention should not be limited to the above discussed embodiments, and should only be defined by the following claims and all equivalents.

We claim:

1. A dispenser for sequentially dispensing sheet product, the dispenser comprising:
a housing configured to receive a stack of sheet product;
a separating spindle with one or more surface projections, the separating spindle configured to frictionally engage the stack;
a separating assembly for rotating the separating spindle; and
a retaining spindle, the separating spindle and retaining spindle being mounted at one end of the housing, spaced apart from each other, and generally defining a dispensing plane from which one or more napkins are dispensed along a dispensing direction.

2. The dispenser of claim 1 further comprising a dispensing magazine, the dispensing magazine having an axis arranged generally along a dispensing direction, the dispensing magazine being configured to hold the stack.

3. The napkin dispenser of claim 1, further comprising a follower having a portion arranged generally parallel to the dispensing plane, the follower slidably mounted in the housing and biased to advance the stack along the dispensing direction so that upon depletion of the stack, the follower contacts the separating spindle and retaining spindle.

4. The napkin dispenser of claim 3, wherein the separating spindle is angled toward the follower at an offset angle of between about 0.5 degrees to about 15 degrees.

5. The napkin dispenser of claim 1, wherein the separating spindle and retaining spindle are spaced apart to engage the stack at opposing end portions and to retain the stack in the housing while the rollers are at rest and are operable to dispense a single sheet of the sheet product upon inward rotation of the separating spindle over a predetermined distance.

6. The napkin dispenser of claim 1, wherein the stack of sheet product is a plurality of napkins and the dispenser is configured to dispense a single napkin upon one revolution of the separating spindle.

7. The napkin dispenser of claim 1, wherein the housing is configured to hold the stack in a horizontal or vertical position.

8. The napkin dispenser of claim 1, wherein the separating spindle is configured to contact the stack at a distance of about ⅛ inch to about ½ inch from at least one of an upper edge of the stack and a lower edge of the stack.

9. The napkin dispenser of claim 1, wherein the separating spindle comprises a surface projection formed of an elastomeric material.

10. The napkin dispenser of claim 1, further comprising a dispensing platform disposed at least partially proximate the dispensing plane to receive dispensed napkins and a dispensing aperture providing access to the dispensing platform.

11. The napkin dispenser of claim 1, wherein the separating spindle is coupled to a motor and the motor is coupled to a controller configured to control rotation of the separating spindle.

12. The napkin dispenser of claim 1, further comprising a controller configured to control the operations of the separating assembly at least partially in response to a signal provided by a proximity sensor configured to detect the presence of a user in the proximity sensor's operating area.

13. A dispenser for sequentially dispensing sheet product from a bundle of sheet product, the dispenser comprising:
a housing defining an axis arranged along a dispensing direction, the housing being configured to receive sheet product;
a feed spindle comprising an engaging portion projecting outwardly from the feed spindle configured to engage sheet product disposed in the housing, the engaging portion extending at least partially along a longitudinal axis of the feed spindle;
a feed mechanism configured to rotate the feed spindle so that the engaging portion comes into contact with sheet product disposed in the housing; and
a retaining spindle disposed in a planar relationship with the feed spindle, the retaining spindle being mounted at one end of the housing spaced apart from the feed spindle, wherein the feed spindle and the retaining spindle are configured rotate to dispense sheet product.

14. The dispenser of claim 13, further comprising a follower disposed generally parallel to the dispensing direction, the follower being configured to advance the sheet product along the dispensing direction such that upon depletion of the stack, the follower contacts or rests proximate the feed spindle and retaining spindle.

15. The dispenser of claim 13, wherein the feed spindle and retaining spindle are configured to retain the sheet product in the housing and upon inward rotation of the feed spindle, the engaging portion engages the sheet product over an engagement area which traverses the feed spindle as it rotates and dispenses product between the spindles.

16. The dispenser of claim 13, wherein the sheet product is a plurality of bundled napkins, and the dispenser is configured to dispense a single napkin upon at least a partial rotation of the feed spindle.

17. The dispenser of claim 13, wherein the dispenser is configured to dispense a single sheet product from the housed sheet product upon at least one revolution of the feed spindle.

18. The dispenser of claim 13, wherein the engaging portion is configured to have an initial contact section at one end of the feed spindle to initially contact a portion of sheet product.

19. The dispenser of claim 18, wherein the initial contact section of the engaging portion of the feed spindle extends along a direction substantially parallel to the longitudinal axis of the feed spindle.

20. The dispenser of claim 18, wherein the initial contact section of the engaging portion of the feed spindle is between about 20% to about 80% of the length of the feed spindle.

21. The dispenser of claim 18, wherein the initial contact section of the engaging portion of the feed spindle extends along the feed spindle over an axial distance of between about 35% to about 65% of the length of the feed spindle.

22. The dispenser of claim 13, wherein the engaging portion has a continuous, unitary structure projecting outwardly from the feed spindle.

23. The dispenser of claim 13, wherein the engaging portion of the feed spindle is arranged about the feed spindle's axis such that it defines from about 0.5 turns to about 2 turns around the feed spindle over the length of the feed spindle.

24. The dispenser according to claim 13, wherein the engaging portion of the feed spindle is arranged about the longitudinal axis of the feed spindle such that it defines from about 0.75 turns to about 1.5 turns around the feed spindle over the length of the feed spindle.

25. The dispenser according to claim 13, wherein the engaging portion is shaped in a single helical arrangement, in a double helical arrangement, to have a plurality of extensions, or as a single, unitary extension.

26. A dispenser comprising:
a housing enclosing a dispensing magazine, the magazine having an axis arranged along a dispensing direction and being configured to receive a plurality of napkins;
a rotatable feed spindle with a napkin engaging portion extending along a longitudinal axis of the feed spindle, the napkin engaging portion having an initial contact section at one end of the feed spindle and a dispensing section displaced along the feed spindle with respect to the initial contact section;
a retaining spindle, the feed spindle and retaining spindle being mounted at one end of the dispensing magazine generally parallel to each other and arranged generally in a dispensing plane;
the feed spindle and retaining spindle being spaced apart to engage opposing end portions of a napkin and retain the napkins in the magazine while the spindles are at rest; and
the feed spindle being configured to exert an inward force on a napkin upon inward rotation at an engagement area of a napkin to dispense a napkin from the housing.

27. The dispenser of claim 26, further comprising a follower generally parallel to the dispensing plane, the follower being slidably mounted and biased to advance the napkins along the dispensing direction of the magazine as napkins are dispensed from the housing.

28. The dispenser of claim 26, wherein the feed spindle is adapted to exert increasing inward frictional force upon the napkins per unit length of the feed roller as it rotates inwardly and the engagement area between the napkin and feed spindle traverses the feed roller from the initial contact section to the dispensing section of the napkin engaging portion.

29. The dispenser of claim 26, wherein the surface area per unit length of the feed spindle of the napkin dispensing section of the napkin engaging portion of the feed spindle is greater than the surface area per unit length of feed spindle of the initial contact section of the napkin engaging portion of the feed spindle.

30. The dispenser of claim 26, further comprising a controller configured to control rotation of the feed spindle so that the feed spindle only rotates to dispense napkins in accordance with a predetermined dispensing operation.

31. A dispenser comprising,
a housing module configured to receive a stack of napkins having panels arranged generally perpendicular to the magazine axis;
a product feed module configured to be detachably affixed to the housing module, the product feed module comprising a separating spindle and a retaining spindle;
the separating spindle having one or more surface projections for frictionally engaging the stack of napkins;
the separating spindle and retaining spindle being mounted at one end of the dispensing magazine generally parallel to each other and arranged generally in a dispensing plane from which one or more napkins are dispensed; and
a controller configured to dispense napkins from an aperture defined by the product feed module according to a predetermined dispensing algorithm.

32. The dispenser of claim 31, wherein the controller is configured to rotate the separating spindle to only provide a single napkin from the stack in response to a request from a user.

33. The dispenser of claim 31, further comprising a sensor to detect the presence of a user proximate the feed module and wherein the controller provides a single napkin from the stack in response a signal provided by the sensor.

34. The dispenser of claim 31, wherein the separating spindle comprises a single projection extending outwardly from a core element of the separating spindle.

35. The dispenser of claim 31, wherein the controller is configured to provide multiple napkins in response to a user's request.

36. A dispenser configured to dispense product in a controlled fashion, the dispenser comprising: a pair of spaced apart spindles disposed proximate housing, the spindles configured to contact the product at varying locations, wherein a first spindle of the pair is configured to separate one or more sheets of product from the product and rotate in tandem with the second spindle of the pair to dispense one or more sheets of product from the housing.

37. The dispenser of claim 36, further comprising a controlling assembly configured to control axial movement of the first spindle.

38. The dispenser of claim 37, wherein the controlling assembly comprises a microprocessor or a manual interface configured to receive input from a user.

39. The dispenser of claim 36, wherein the first spindle is configured to separate at least one sheet from the product in response to one or more partial or full revolutions of the first spindle.

40. The dispenser of claim 36, further comprising a processor configured to determine whether the product is configured to be dispensed from the housing, and upon determining that the product is not appropriately configured entering a lock-out state.

41. The dispenser of claim 36, further comprising a processor coupled to a sensor, the processor configured to control the first spindle based at least in part on a sensor signal to control dispensing of the one or more sheets from the housing.

42. The dispenser of claim 36, wherein the first spindle comprises at least one projection raised from the first spindle's outer surface, the at least one projection being configured to engage the product and separate the one or more sheets from the product.

43. The dispenser of claim 36, wherein the first spindle is configured to rotate independently from the second spindle so that rotation of the first spindle controls separation of the one or more sheets from the product.

44. The dispenser of claim 36, further comprising a light source configured to direct light toward the product, a light detector configured to receive light reflected by the product, a controller to control dispensing operations based in part on a signal provided by the light detector.

45. The dispenser of claim 36, wherein the spindles are disposed in a feed module configured to be detachably affixed to the housing.

46. A method of dispensing sheet product from a dispenser, the method comprising:
arranging a plurality of axial members for use with a housing that holds product to be dispensed;
configuring a first axial member of the plurality of axial members to engage and rotatably separate one or more sheets of product; and
arranging the first axial member and a second axial member to allow a predetermined number separated sheets to be dispensed from the housing and retain un-separated sheets in the housing.

47. The method of claim 46, further comprising configuring the housing to be a modular component to interface with a second modular component that holds the first axial member and the second axial member.

48. The method of claim 46, further comprising providing a processor for controlling rotation of the first axial member to control dispensing of product from the housing.

49. The method of claim 46, further comprising configuring the first axial member to comprise at least one projection to engage the product to be dispensed.

50. The method of claim 46, further comprising configuring the first axial member and the second axial member to have different rotational characteristics for dispensing of one or more sheets from the product.
